(19) United States
(12) Patent Application Publication
(10) Pub. No.: US 2011/0025204 A1
(43) Pub. Date: Feb. 3, 2011

(54) METAL HALIDE LAMP, METAL HALIDE LAMP LIGHTING, AND HEAD LIGHT

(76) Inventors: Makoto Deguchi, Ehime-ken (JP); Koji Tanabe, Ehime-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/996,936

(22) PCT Filed: Jul. 26, 2006
(86) PCT No.: PCT/JP2006/314807

§ 371 Date: Apr. 16, 2010

(30) Foreign Application Priority Data
Jul. 28, 2005 (JP) 2005-219716

(51) Int. Cl. H01J 61/18

(52) U.S. Cl. 313/638

(57) ABSTRACT

[Problems] A mercury-free metal halide lamp improved in light beam maintaining rate by limiting an excessive temperature rise at the upper portion of an arc tube at starting, a metal halide lamp lighting device using this and a head light.

[Means of Solving Problems] The metal halide lamp MHL comprises a translucent airtight container (1) having a discharge space (1c) inside thereof, the portion thereof facing the center part having a wall-thickness of at least 1.7 mm, a pair of electrodes (1b) sealed in the discharge space so as to face each other across a gap, and discharge medium sealed so as to contain a halide compound as a light emitting metal and rear gas but not to contain mercury (Hg) intrinsically, wherein a lamp voltage ratio V₁₆/V₀ satisfies V₁₆/V₀≧1.5 when lighting so that a lamp power supplied from starting up to stabilized lighting is larger than a lamp power supplied at stabilized lighting, where a lamp voltage 16 sec after starting is V₁₆(V) and the lowest lamp voltage after starting is V₀(V).

### TECHNICAL FIELD

The present invention relates to a mercury-free metal halide lamp, and a metal halide lamp lighting device and a head light using this.

### BACKGROUND ART

A so-called mercury-free metal halide lamp in which mercury is not substantially contained (which will be referred to as a “mercury-free lamp” hereinafter for convenience's sake) has been already known (see, e.g., Patent Document 1). In the mercury-free lamp, a halide of metal, e.g., zinc which has a relatively high vapor pressure and hardly emits a light in a visible range is generally included in place of mercury which is included as a buffer substance for formation of a conventional lamp voltage.

The mercury-free lamp is expected and developed as a metal halide lamp for a head light of an automobile from which use of environmental burden materials is to be totally abolished in particular. In case of this metal halide lamp, a luminous flux which is 80% of a rated luminous flux must be emitted after four seconds from an initial rise based on standards (see Non-patent Literature 1). However, it is generally difficult for the mercury-free lamp to satisfy the above conditions since mercury light emission cannot be obtained, a high vapor pressure of mercury cannot be acquired immediately after lighting and evaporation of a metal halide thereby becomes slow.

Thus, to satisfy the above conditions, a larger lamp power than that in a mercury containing lamp is supplied for a longer time than that of the mercury containing lamp immediately after starting.

Patent Document 1: Japanese Patent Application Laid-open No. 238488-1999

Non-patent Literature 1: Japan Electric Lamp Manufacturers Association Standard JEL 215 “Automobile Head Light HID Light Source”

### DISCLOSURE OF INVENTION

### Problem to be Solved by the Invention

However, when the large lamp power is supplied as explained above, since a temperature at an upper portion of a luminous bulb is precipitously increased at starting, there is a problem, e.g., occurrence of white turbidity which leads to a reduction in a luminous flux maintenance factor. It has been revealed that this problem particularly becomes prominent when a phenomenon that a temperature at an upper portion of a luminous bulb is excessively increased in starting, i.e., so-called overshoot of a temperature occurs.

It is to be noted that the overshoot of a temperature at the upper portion of the luminous bulb is an intrinsic problem of the mercury-free lamp. That is, in the mercury-free lamp, in order to obtain a predetermined lamp voltage, a zinc iodide is preferably added as a so-called second halide which is a metal halide having a low vapor pressure and a small amount of light emission in a visible range in place of mercury, a charge pressure of xenon is set to a high value, lift of an arc during lighting thereby becomes considerable, and hence overshoot of a temperature at the upper portion of the luminous bulb is apt to occur.

Therefore, the present inventor has discovered as a result of various experiments that precipitating an initial rise of the lamp voltage at starting enables suppressing an excessive increase in a temperature at the upper portion of the luminous bulb at starting.

It is an object of the present invention to provide a mercury-free metal halide lamp having an improved luminous flux maintenance factor by limiting overshoot of a temperature in a light-transmitting hermetic vessel at starting, and a metal halide lamp lighting device and a head light using this.

### Means for Solving Problem

According to the present invention, there is provided a metal halide lamp comprising: a light-transmitting hermetic vessel which has a discharge space therein and whose part facing a central part of the discharge space has a wall thickness of 1.7 mm or above; a pair of electrodes hermetically disposed to face each other at an interval in the discharge space of the light-transmitting hermetic vessel; and a discharge medium which contains a halide of a light-emitting metal and a rare gas, but does not substantially contain mercury (Hg), and is included in the discharge space of the light-transmitting hermetic vessel, the lamp being configured such that, when performing lighting in such a manner that a lamp power supplied from starting up to stable lighting becomes larger than a lamp power supplied at stable lighting, a lamp voltage ratio V₁₆/V₀ satisfies the following expression:

V₁₆/V₀≧1.5

where V₁₆ (V) is a lamp voltage 16 seconds after starting and V₀ (V) is the lowest lamp voltage after starting.

According to the present invention, there is provided a metal halide lamp lighting device comprising: a metal halide lamp according to claim 1; and an electronic operating circuit which energizes the metal halide lamp.

According to the present invention, there is provided a head light comprising: a head light main body; a metal halide lamp according to claim 1 arranged in the head light main body; and an operating circuit which energizes the metal halide lamp.

### EFFECT OF THE INVENTION

According to the present invention, it is possible to provide the mercury-free metal halide lamp having a luminous flux maintenance factor improved without sacrificing a luminous flux initial rise by suppressing occurrence of overshoot of an increase in a temperature of the light-transmitting hermetic vessel after starting, and the metal halide lamp lighting device and the head light using this.

### BRIEF DESCRIPTION OF DRAWINGS

FIG. 1 is a side view showing an embodiment for carrying out the present invention as a metal halide lamp for an automobile head light;

FIG. 2 is a graph showing an influence of a wall thickness t of a light-transmitting hermetic vessel in a relationship between a ratio V₁₆/V₀ of a lamp voltage and a luminous flux maintenance factor;

FIG. 3 is a graph showing an increase in a temperature of the light-transmitting hermetic vessel after starting according to the present invention in comparison with that in a comparative example;

FIG. 4 is a graph showing a change in a lamp power that is supplied to the metal halide lamp at starting;

FIG. 5 is a graph showing a ratio V₁₆/V₀ of a lamp voltage obtained based on data depicted in Table 1 with an inclusion amount of ZnI₂ being determined as a parameter;

FIG. 6 is a graph showing a relationship between the ratio V₁₆/V₀ of the lamp voltage and the luminous flux maintenance factor in Example 1;

FIG. 7 is a graph showing an increase in a temperature of a light-transmitting hermetic vessel in each of Example 2 and a comparative example;

FIG. 8 is a graph showing the luminous flux maintenance factor in each of Example 2 and the comparative example;

FIG. 9 is a conceptual view showing an automobile head light as an embodiment for carrying out a head light according to the present invention; and

FIG. 10 is a circuit diagram showing an operating circuit.

### EXPLANATIONS OF LETTERS OR NUMERALS

1 light-transmitting hermetic vessel
1a enveloping portion
1a1 sealing portion
1a2 sealing tube
1a3 bottom surface
1a4 upper surface
1a5 upper outer surface
1a6 lower outer surface
1b electrode
1c discharge space
2 sealing metal foil
3A external lead wire
3B external lead wire
IT luminous bulb

### BEST MODE(S) FOR CARRYING OUT THE INVENTION

A mode for carrying out the present invention will now be explained hereinafter with reference to the drawings.

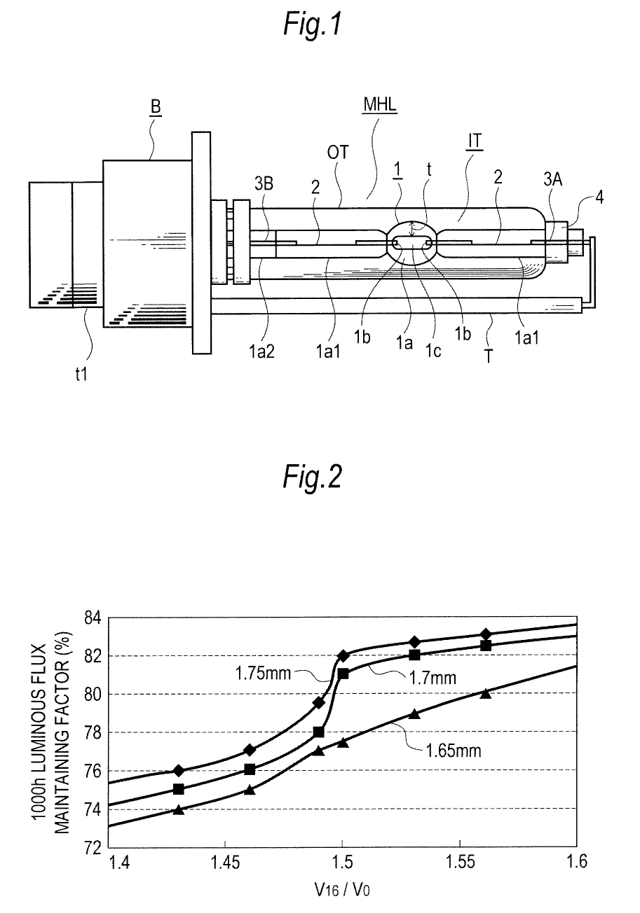

FIG. 1 is a front view showing an embodiment for carrying out the present invention as a metal halide lamp for an automobile head light. In this embodiment, a metal halide lamp HML includes a luminous bulb IT, an insulating tube T, an outer bulb OT, and a base B.

### [Luminous Bulb IT]

The luminous bulb IT includes a light-transmitting hermetic vessel 1, a pair of electrodes 1b and 1b, a pair of external lead wires 3A and 3B, and a discharge medium.

(Light-Transmitting Hermetic Vessel 1)

The light-transmitting hermetic vessel 1 is light-transmittable and refractory, and includes an enveloping portion 1a in which a discharge space 1c is formed. An inner capacity of the enveloping portion can be appropriately set in accordance with an application of the metal halide lamp, but it is generally 0.1 cc or below for a small metal halide lamp which is preferable to apply the present invention. Further, in case of a head light, the inner capacity is preferably 0.05 cc or below.

The discharge space 1c can be formed into an arbitrary shape, e.g., a substantially columnar shape, a spherical shape, or an elliptic spherical shape. In case of the head light, the discharge space 1c preferably has a substantially columnar shape. On the other hand, an outer surface of the enveloping portion 1a of the light-transmitting hermetic vessel 1 has a rotating secondary curved surface shape, e.g., an elliptic spherical shape or a spindle shape.

Furthermore, preferable sizes of the enveloping portion 1a and the discharge space 1c formed therein in the light-transmitting hermetic vessel 1 of the metal halide lamp MHL for an automobile head light are as follows. That is, a length of the enveloping portion 1a in a bulb axis direction is 7.6 to 8.2 mm, or preferably 7.8 to 8.0 mm; an internal diameter of the discharge space 1c is 2.2 to 2.9 mm, or preferably 2.4 to 2.7 mm; an external diameter of the same is 5.6 to 6.9 mm, or preferably 5.8 to 6.5 mm; and an inner capacity of the discharge space 1c is 20 to 35 μl, or preferably 25 to 30 μl.

In the present invention, a wall thickness t of a part facing a central part of the discharge space, i.e., a central part of the enveloping portion 1a in the bulb axis direction is 1.7 mm or above. The wall thickness t relates to, e.g., an increase in a temperature of the enveloping portion 1a of the light-transmitting hermetic vessel 1 at starting or a mechanical strength. When the wall thickness t is less than 1.7 mm, even if a later-explained ratio of a lamp voltage is 1.5 or above, a considerable improvement in a luminous flux maintenance factor cannot be obtained. Moreover, an increase in a temperature of the light-transmitting hermetic vessel 1 becomes faster, and an effect of suppressing occurrence of overshoot cannot be obtained at starting. Therefore, the wall thickness t which is less than 1.7 mm cannot be adopted. In terms of suppression of occurrence of the overshoot, there is no upper limit in the wall thickness t. It is to be noted that the wall thickness t is preferably 1.72 mm or above.

However, a temperature during lighting of the luminous bulb IT becomes too low as the wall thickness is increased, thereby reducing a light emission efficiency. Additionally, an external diameter of the light-transmitting hermetic vessel 1 becomes large, and an external diameter of the outer bulb OT accommodating the luminous bulb IT must be properly increased. Therefore, since the outer shape of the metal halide lamp MHL is increased, it is good enough to practically set the wall thickness to 2 mm or below, or preferably 1.9 mm or below.

Further, when the discharge space 1c has a substantially columnar shape, the wall thickness of the enveloping portion 1a is generally maximum at the central part in the bulb axis direction, and it is gradually reduced toward both ends. As a result, heat transmission of the light-transmitting hermetic vessel 1 becomes excellent, and an increase in a temperature of the discharge medium which has adhered to the bottom surface and the side inner surface of the discharge space 1c is accelerated, which effectively functions to precipitate an initial rise of a luminous flux.

Further, when the light-transmitting hermetic vessel 1 is “light-transmittable and refractory”, this means that a light guiding portion from which light emission is led to the outside of at least the enveloping portion 1a is light-transmittable and at least fire resistance of enabling sufficient resistance against a regular operating temperature of the metal halide lamp. Therefore, the light-transmitting hermetic vessel 1 can be formed of any material as long as it has fire resistance and the necessary light guiding portion can lead a visible light in a desired wavelength band generated due to discharge to the outside. For example, light-transmitting ceramics or quartz glass can be used. It is to be noted that quartz glass having a high in-line transmittance factor is generally used in case of the metal halide lamp for a head light. It is to be noted that, when the light-transmitting hermetic vessel 1 is formed of quartz glass, a transparent film having halogen resisting properties or halide resisting properties can be formed on an inner surface of the enveloping portion 1a of the light-transmitting hermetic vessel 1 or an inner surface of the light-transmitting hermetic vessel 1 can be reformed as required.

When the light-transmitting hermetic vessel 1 is formed of quartz glass, a pair of extending sealing portions 1a1 and 1a1 can be formed at both ends of the enveloping portion 1a in the bulb axis direction. The pair of sealing portions 1a1 and 1a1 are means which seal the enveloping portion 1a, have shaft portions of later-explained electrodes 1b embedded therein, and contribute to hermetically leading a current from a non-illustrated electronic operating circuit to the electrodes 1b, and they are integrally extended from both ends of the enveloping portion 1a. Furthermore, in order to hermetically dispose the electrodes 1b and hermetically lead a current from the electronic operating circuit to the electrodes 1b, appropriate hermetic sealing conducting means (which is preferably a sealing metal foil 2) is hermetically embedded in these portions.

It is to be noted that the sealing metal foil 2 is means which is hermetically embedded in each sealing portion 1a1 and enables each sealing portion 1a1 to function as a current continuity conductor while cooperating to hermetically maintaining the inside of the enveloping portion 1a of the light-transmitting hermetic vessel 1, and molybdenum (Mo) or a rhenium-tungsten alloy (Re—W) can be used as a material for the sealing metal foil when the light-transmitting hermetic vessel 1 is made of quartz glass. Since molybdenum is oxidized when a temperature reaches approximately 350° C., the sealing metal foil 2 is embedded so that a temperature at an end portion on the outer side becomes lower than this value.

Although a method of embedding the sealing metal foil 2 in the sealing portion 1a1 is not restricted in particular, a method of sealing under a reduced pressure or a pinch sealing method can be solely used or a combination of these method can be adopted, for example. In case of a small metal halide lamp which has a structure where an inner capacity of the enveloping portion 1a is 0.1 cc or below and a rare gas, e.g., xenon (Xe) is put at 5 or more atmospheres at a room temperature and which is used for, e.g., a head light, the latter is preferable.

Furthermore, in FIG. 1, after the left sealing portion 1a1 is formed, a sealing tube 1a2 is integrally extended to the inside of a later-explained base B from an outer end portion of the sealing portion 1a1 without being cut off.

(Pair of Electrodes 1b and 1b)

The pair of electrodes 1b and 1b are hermetically disposed at both ends in the enveloping portion 1a of the light-transmitting hermetic vessel 1 to face each other at an interval. They are arranged at both ends of the discharge space 1c to be distanced from each other in such a manner that they face the discharge space 1c of the metal halide lamp MHL.

Moreover, it is generally good enough that a diameter of a shaft portion of each of the pair of electrodes 1b and 1b is set to an appropriate value in the range of 0.25 to 0.35 mm, or preferably 0.25 to 0.35 mm.

Additionally, each of the pair of electrodes 1b and 1b has a shaft portion made of a refractory metal selected from a group including tungsten (W), doped tungsten, thorium tungsten, rhenium (Re), a tungsten-rhenium alloy (W—Re), and others, a proximal end of each shaft portion is welded to the sealing metal foil 2 to be embedded in the sealing portion 1a1, an intermediate part of the shaft portion is gently supported by the sealing portion 1a1 of the light-transmitting hermetic vessel 1, and the electrodes 1b and 1b are arranged at both ends of the discharge space 1c to face each other at an interval in such a manner that their distal ends face the discharge space 1c of the light-transmitting hermetic vessel 1.

Additionally, when the metal halide lamp MHL is used for a head light, the shaft portion of each of the pair of electrodes 1b and 1b is extended to the distal end as it is without increasing its diameter, and the distal end is formed into a truncated conical shape, a semispherical shape, or a semielliptic spherical shape to facilitate stabilization of a starting point of a discharge arc. Further, when a small protrusion is formed at the distal end in addition to this, an effect is synergistically increased. It is to be noted that the distal end of the electrode 1b is not illustrated but has a semispherical shape having a curvature that is ½ of a diameter of an electrode shaft in this embodiment.

However, a part near the distal end of the electrode 1b can be formed into, e.g., a substantially spherical shape or an elliptic spherical shape having a larger diameter than that of the shaft portion as required. That is, since the number of times of turning on and off the lamp is extremely increased or a larger current than that in a steady state is flowed at starting, increasing the diameter of the entire electrode 1b in association with this causes a constituting material of the light-transmitting hermetic vessel 1 which is in contact with each electrode shaft to receive a thermal stress every time turning on and off the lamp is performed, and hence cracks are apt to occur. Therefore, forming a large-diameter portion near the distal end of the electrode 1b enables the electrode 1b to cope with turning on and off the lamp, but cracks hardly occur since the shaft portion does not have a large diameter.

Further, each electrode 1b may operate with either an alternating current or a direct current. When it operates with the alternating current, the pair of electrodes 1b have the same structure. When it operates with the direct current, since a temperature of an anode is generally intensively increased, forming the large-diameter portion near the distal end enables increasing a heat radiation area and coping with the frequent turning on and off of the lamp. On the other hand, the large-diameter portion does not have to be formed to a cathode.

(Pair of External Lead Wire 3A and 3B)

A distal end of each of the pair of external lead wires 3A and 3B is welded to the other end of the sealing metal foil 2 in the sealing portion 1a1 at each of both ends of the light-transmitting hermetic vessel 1, and a proximal end side of the same is led to the outside. In FIG. 1, the external lead wire 3A led out to the right-hand side from the luminous bulb IT is folded back along the later-explained outer bulb OT at an intermediate portion thereof, introduced into the later-explained base B, and connected with one t1 of non-illustrated base terminals. In FIG. 1, the external lead wire 3B led out to the left-hand side from the luminous bulb IT is extended along the bulb axis in the sealing tube 1a2, introduced into the base B, and connected with the other one (not shown) of the base terminals.

(Discharge Medium)

The discharge medium contains a metal halide and a rare gas, but substantially does not contain mercury.

The metal halide is a halide of a metal containing at least a light-emitting metal, and preferably contains halides of a plurality of metals selected from a group including scandium (Sc), sodium (Na), indium (In), zinc (Zn), and a rare-earth metal as the metal halide lamp for a head light. However, the discharge medium is allowed to secondarily contain halides of metals which are not included in the group in addition to a configuration including the halides of the metals belonging to the group. For example, when a halide of thallium (Tl) is added as a main light-emitting material, a light-emitting efficiency can be further increased.

Furthermore, since a halide of zinc (Zn) relatively has a high vapor pressure and less light emission in a visible range, it mainly contributes to formation of a lamp voltage. However, as a metal halide for formation of a lamp voltage, halides of metals in the following group can be used in place of or in addition to zinc as desired. That is, when halides of one or more metals selected from the group including magnesium (Mg), cobalt (Co), chrome (Cr), manganese (Mn), antimony (Sb), rhenium (Re), gallium (Ga), tin (Sn), iron (Fe), aluminum (Al), titanium (Ti), zirconium (Zr), and hafnium (Hf) is contained, the lamp voltage can be increased to a desired value. Because the metals in the above-explained group are metals that do not emit a light in a visible range due to their high vapor pressures or metals that have relatively small amounts of light emission, they are not expected as light-emitting metals that provide luminous fluxes, but are metals mainly preferable for formation of the lamp voltage.

The rare gas functions as a starting gas and a buffering gas, and one or more of rare gases, e.g., argon (Ar), krypton (Kr), and xenon (Xe) can be used. Moreover, as the metal halide lamp MHL for an automobile head light, in order to precipitate an initial rise of a luminous flux or emit a white light immediately after starting, xenon is put at 5 atmospheres or above, or preferably in the range of 7 to 18 atmospheres, or more preferably in the range of 8 to 13 atmospheres, or it is put in such a manner that a pressure in the discharge space at the time of lighting becomes 50 atmospheres or above. As a result, when a vapor pressure of a light-emitting metal is low immediately after starting, white light emission of Xe can be contributed as a luminous flux in the initial rise.

In the present invention, as the embodiment of the metal halide lamp for an automobile head light, it is desirable to set a total inclusion amount of a metal halide per unit inner capacity of the discharge space 1c to the range of 0.015 to 0.030 mg/μl, and desirable to set the total inclusion amount of the same to 0.3 to 0.9 mg, or preferably 0.5 to 0.7 mg. As types of the halide of the light-emitting metal, adopting NaI and ScI₃ as main components is preferable. Primarily, as the metal halide for formation of the lamp voltage, putting 0.1 mg or above of ZnI₂ is preferable. Setting a mass percentage of NaI with respect to a total amount of the metal halide to 48 to 52% is desirable.

(Mercury)

In the present invention, there is a description “mercury is not substantially contained”, and this means that not only mercury (Hg) is not contained at all but also presence of mercury whose amount is less than 2 mg, or preferably 1 mg or below per 1 cc of the inner capacity of the hermetic vessel is allowed.

However, containing no mercury at all is environmentally desirable. In a case where the lamp voltage of the discharge lamp is increased to a necessary value by using a mercury vapor like a conventional technology, considering the fact that 20 to 40 mg of mercury is contained per 1 cm³ of the inner capacity of the hermetic vessel in a short arc shape or 50 mg or above of mercury is contained depending on circumstances, it can be said that the amount of mercury is substantially extremely small.

(Types of Halogens)

As types of halogens constituting halides, iodine is most appropriate in halogens in relation to reactiveness, and at least the main light-emitting metal is mainly included as an iodide. However, different halides, e.g., an iodide and a bromide can be also used as required.

### [Insulating Tube T]

The insulating tube T is formed of ceramics, and the insulating tube T covers the external lead wire 3A.

### [Outer Bulb OT]

In the present invention the metal halide lamp MHL is allowed to include the outer bulb OT as desired. The outer bulb OT is formed of, e.g., quartz glass or high-silicate glass, and it is means for accommodating at least a primary portion of the luminous bulb IT therein. Additionally, it blocks off ultraviolet rays radiated from the luminous bulb IT to the outside, mechanically protects the luminous bulb IT, prevents adhesion of fingerprints or fat of a person from becoming a factor of devitrification when the light-transmitting hermetic vessel 1 of the luminous bulb IT is touched by hands, or keeps the light-transmitting hermetic vessel 1 warm.

Further, the inside of the outer bulb OT may be hermetically closed with respect to outside air in accordance with its purpose, or air or an inert gas whose pressure is equal to outside air or reduced may be put in the outer bulb OT. Furthermore, the outer bulb OT may communicate with outside air as required.

Moreover, a light shielding film may be arranged on an outer surface or an inner surface of the outer bulb OT.

In the illustrated embodiment, when forming the outer bulb OT, both ends of the outer bulb OT may be glass-welded to the sealing portions extending in the bulb axis direction from both ends of the light-transmitting hermetic vessel 1 so that the outer bulb OT is supported by the light-transmitting hermetic vessel 1. The outer bulb OT has ultraviolet protection performance and accommodates the luminous bulb IT therein, and reduced-diameter portions 4 at both ends of the outer bulb OT are glass-welded to the sealing portions 1a1 of the discharge vessel IT. However, the inside is not hermetic and communicates with outside air.

### [Base B]

In the present invention, the metal halide lamp MHL is allowed to include the base B as desired. The base B is means for connecting the metal halide lamp MHL with a non-illustrated operating circuit and mechanically supporting the same, and it is standardized for an automobile head light, perpendicularly supports the luminous bulb IT and the outer bulb OT along a central axis and is detachably disposed to a rear surface of the automobile head light in the illustrated embodiment.

### [Lamp Voltage Ratio V₁₆/V₀]

In the present invention, the metal halide lamp MHL is configured in such a manner that a lamp voltage ratio V₁₆/V₀ satisfies an expression V₁₆/V₀≧1.5 when lighting so that a lamp power supplied from starting up to stable lighting is larger than a lamp power supplied at stable lighting. Here, a lamp voltage V₁₆ is a lamp voltage 16 seconds after starting the metal halide lamp MHL. A lamp voltage V₀ is the lowest lamp voltage immediately after starting. However, a lamp voltage in a period where a pulse voltage appears between the electrodes when a starting pulse is applied to a space between the electrodes is excluded from a calculation target of the lamp voltage ratio.

Generally, when the pulse voltage is applied, the metal halide lamp MHL is started, but the lamp voltage after application of this pulse voltage is the lowest voltage. This lowest lamp voltage is determined as V₀. Furthermore, the lamp voltage gradually starts increasing from the lowest state. In a process where the lamp voltage increases, the lamp voltage increases while its increase rate is gradually saturated, and the metal halide lamp MHL reaches stable lighting when complete saturation is achieved. Generally, 16 seconds after starting, saturation of the lamp voltage starts becoming considerable, and a tendency that a difference between a lamp voltage causing overshoot of an increase in a temperature of the light-transmitting hermetic vessel 1 and a lamp voltage causing no overshoot becomes relatively large is observed. Thus, determining the lamp voltage 16 seconds after starting as V₁₆, the lamp voltage ratio V₁₆/V₀ is obtained.

As a result of many experiments conducted by the present inventor and others, it was confirmed that satisfying the expression V₁₆/V₀≧1.5 enables suppressing an excessive increase in a temperature of the light-transmitting hermetic vessel 1 at starting. That is, when the metal halide lamp MHL is configured to quicken an initial rise of the lamp voltage after starting, the expression can be readily satisfied. On the other hand, it was also confirmed that overshoot of an increase in a temperature of the light-transmitting hermetic vessel 1 is apt to occur when the lamp voltage ratio V₁₆/V₀ is less than 1.5. When overshoot of an increase in a temperature of the light-transmitting hermetic vessel 1 occurs, white turbidity is produced at a position around an upper inner surface of the enveloping portion 1a of the light-transmitting hermetic vessel 1. As a result, a luminous flux maintenance factor of the metal halide lamp MHL is reduced.

Moreover, since overshoot of an increase in a temperature of the light-transmitting hermetic vessel 1 is also affected by the wall thickness t of the part of the light-transmitting hermetic vessel 1 facing the discharge space 1c, an effective advantage can be obtained only after the wall thickness t is 1.7 mm or above and the expression is satisfied.

In the present invention, as to the expression, satisfying the expression can suffice, and any other structures do no matter. It is to be noted that making a design while considering the balance of the entire lamp enables satisfying the expression. Additionally, the lowest lamp voltage V₀ after starting is affected by the balance of, e.g., a charge pressure of a rare gas, an electrode design, a distance between the pair of electrodes, and others.

Further, when the lowest lamp voltage V₀ after starting is relatively low, a tendency that overshoot of a temperature of the light-transmitting hermetic vessel 1 is apt to occur is observed. Thus, it is good enough to configure the lamp in such a manner that the lamp voltage V₀ becomes 22 V or above, or preferably 26 V or above.

FIG. 2 is a graph showing an influence of the wall thickness t of the light-transmitting hermetic vessel in a relationship between the lamp voltage ratio V₁₆/V₀ and the luminous flux maintenance factor. In the drawing, an abscissa represents the lamp voltage ratio V₁₆/V₀ and an ordinate represents a 1000 h luminous flux maintenance factor (%). Furthermore, curves of 1.65 mm, 1.7 mm, and 1.75 mm represent values of the wall thickness t, respectively.

As can be understood from the drawing, when the wall thickness t is 1.7 mm or 1.75 mm, the luminous flux maintenance factor is considerably improved and the effect of the present invention can be obtained in the range where the lamp voltage ratio V₁₆/V₀ is 1.5 or above. On the other hand, when the wall thickness t is 1.65 mm, only the luminous flux maintenance factor is gently increased, and the effect of the present invention cannot be obtained.

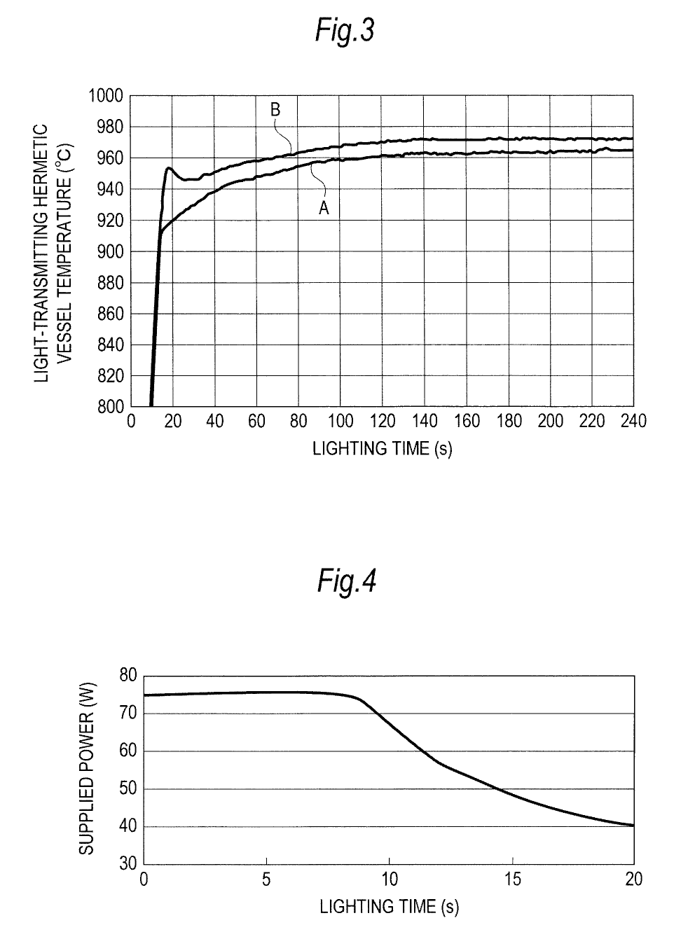

FIG. 3 is a graph showing an increase in a temperature of the light-transmitting hermetic vessel after starting in the present invention in comparison with a comparative example. In the drawing, an abscissa represents a lighting time (s), and an ordinate represents a temperature (° C.) of the light-transmitting hermetic vessel. Moreover, a curve A represents the present invention, and a curve B represents the comparative example.

As can be understood from the drawing, in the present invention, overshoot does not occur in an increase in a temperature of the light-transmitting hermetic vessel 1 after starting. On the other hand, in the comparative example, overshoot occurs. It is to be noted that the lamp voltage ratio V₁₆/V₀ is 1.46 in the comparative example.

FIG. 4 is a graph showing a change in a lamp power supplied to the metal halide lamp at starting. In the drawing, an abscissa represents a lighting time (s) and an ordinate represents a supplied power (W), respectively.

Although the drawing shows an example, as can be understood from the drawing, in the present invention, a lamp power which is twofold or above of a rated lamp power is continuously supplied in a period of approximately 4 to 10 seconds immediately after starting, the lamp power is then gradually reduced, and lighting is performed so that the lamp power supplied up to stable lighting becomes larger than the lamp power supplied at stable lighting.

Examples and a result of testing a change in an initial rise of the lamp voltage when the discharge medium is varied will now be explained.

### Example 1

A metal halide lamp has a structure depicted in FIG. 1. Light-transmitting hermetic vessel 1: an enveloping portion 1a has an internal diameter of 2.6 mm, an external diameter of 6.2 mm, and a wall thickness t of 1.8 mm, a length of the enveloping portion is 7.8 mm, an inner capacity of a discharge space is 25 μl

Electrode 1b: a shaft diameter of the electrode is 0.3 mm, a distance between the pair of electrodes is 4.4 mm
Discharge medium: a metal halide ScI₃—NaI—ZnI₂, a rare gas Xe 10 atm
Supplied power immediately after starting: 75 W
Lamp power in a stable state: 35 W
Lamp voltage in a stable state: 45 V

Next, Table 1 shows initial rise data of the same lamp voltage as that depicted in Table 1 when a total amount of the halide is fixed to 0.6 mg and an inclusion amount of ZnI₂ is changed in Example 1.

TABLE 1

| | | | 10 s | 12 s | 14 s | 16 s | 18 s |
|---|---|---|---|---|---|---|---|
| | V0 (V) | 8 s (V) | (V) | (V) | (V) | (V) | (V) |
| 0.0018 mg/μl | 23.0 | 26.0 | 26.8 | 28.4 | 29.2 | 32.8 | 33.6 |
| 0.0025 mg/μl | 23.0 | 25.5 | 26.5 | 28.9 | 32.0 | 34.2 | 35.5 |
| 0.0030 mg/μl | 23.0 | 25.7 | 26.9 | 29.0 | 32.8 | 34.5 | 36.0 |
| 0.0037 mg/μl | 23.0 | 26.5 | 27.5 | 29.9 | 34.0 | 35.9 | 37.2 |

Table 1 shows inclusion amounts of ZnI₂ in columns at the left end in a vertical direction. It is to be noted that an inclusion rate of ZnI₂ with respect to a total amount of the halide is 10.5% when the inclusion amount of ZnI₂ is 0.0018 mg/μl, it is 14.7% when the same is 0.0025 mg/μl, it is 16.8% when the same is 0.0030 mg/μl, and it is 21.7% when the same is 0.0037 mg/μl.

Obtaining the ratio V₁₆/V₀ of the lamp voltage V₁₆ 16 seconds after starting and the lowest lamp voltage V₀ from the data in Table 1, results are as follows. That is, the ratio is 1.43 when the inclusion amount of ZnI₂ is 0.0018 mg/μl, it is 1.49 when the same is 0.0025 mg/μl, it is 1.50 when the same is 0.0030 mg/μl, and it is 1.56 when the same is 0.0037 mg/μl.

Therefore, it can be understood that the scope of the invention is achieved when the inclusion amount of ZnI₂ is 0.0030 mg/μl or above in Example 1. It is to be noted that as inventions of a mercury-free lamp including a zinc iodine, there is Japanese Patent Application Laid-open No. 2004-288629, Japanese Patent Application Laid-open No. 2003-303571, and others. Although these publications have a description that a voltage in a stable state is adjusted to a preferable value that is approximately 45 V for the purpose of putting zinc, they do not have a description that an initial rise of the voltage is quickened. Further, they do not explain about a wall thickness in particular.

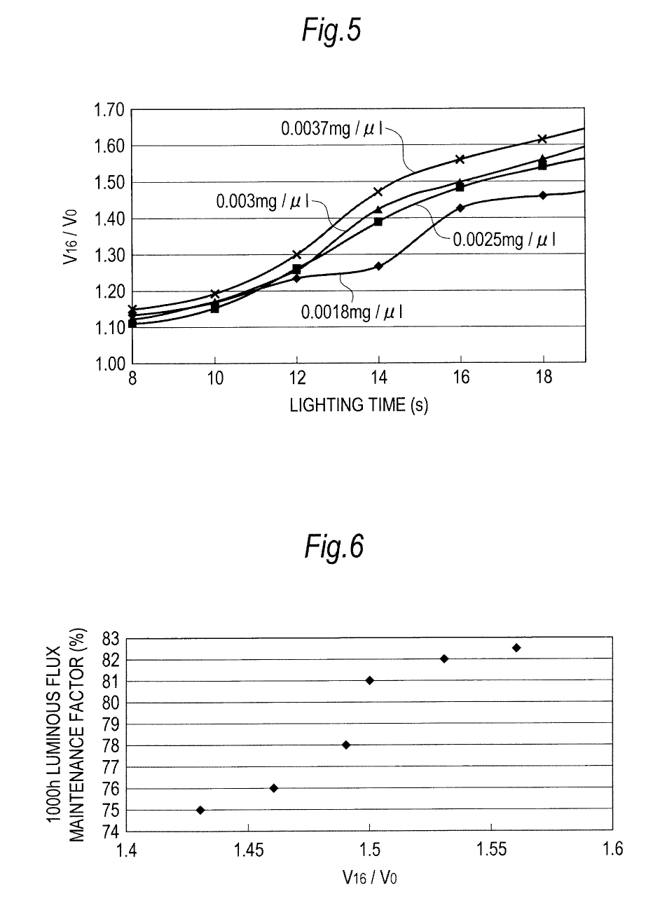

FIG. 5 is a graph showing the lamp voltage ratio V₁₆/V₀ obtained based on the data in Table 1 with an inclusion amount of ZnI₂ being used as a parameter. In the drawing, an abscissa represents a lighting time (s) and an ordinate represents the lamp voltage ratio V₁₆/V₀, respectively.

As can be understood from the drawing, in the metal halide lap having a large lamp voltage ratio V₁₆/V₀, an initial rise of the lamp voltage is fast. Furthermore, the initial rise of the lamp voltage is fast when an inclusion rate of ZnI₂ is high.

FIG. 6 is a graph showing a relationship between the lamp voltage ratio V₁₆/V₀ and a luminous flux maintenance factor in Example 1. In the drawing, an abscissa represents the lamp voltage ratio V₁₆/V₀ and an ordinate represents a 1000 h luminous flux maintenance factor (%), respectively.

It can be understood from the drawing that the luminous flux maintenance factor becomes considerably excellent when the lamp voltage ratio V₁₆/V₀ is 1.5 or above.

As a second embodiment different from the first embodiment carrying out the present invention, the following structure can be adopted. That is, the second embodiment is a metal halide lamp comprising: a light-transmitting hermetic vessel which has a discharge space therein and whose part facing a central part of the discharge space has a wall thickness of 1.7 mm or above; a pair of electrodes hermetically disposed to face each other at an interval in the discharge space of the light-transmitting hermetic vessel; and a discharge medium which contains a metal halide and a rare gas, but does not substantially contain mercury (Hg), and is included in the discharge space of the light-transmitting hermetic vessel, the metal halide including a sodium halide, a scandium halide, and a zinc halide whose total inclusion amount is 0.015 to 0.030 mg/μl with respect to an inner capacity of the discharge space of the light-transmitting hermetic vessel, a ratio of the sodium halide being 48 to 52 mass %, an amount of the zinc halide being 1 mg or above.

With this configuration, an initial rise of a lamp voltage at starting is precipitated, and overshoot of an increase in a temperature of the light-transmitting hermetic vessel 1 does not occur, thereby suppressing occurrence of white turbidity and improving a luminous flux maintenance factor.

It is to be noted that FIG. 1 and the explanation of the luminous bulb IT, the insulating tube T, the outer bulb OT, and the base B quoted in the description of the first embodiment can be also applied to the second embodiment.

### Example 2

A metal halide lamp has a structure depicted in FIG. 1. Light-transmitting hermetic vessel 1: an enveloping portion 1a has an internal diameter of 2.6 mm, an external diameter of 6.2 mm, and a wall thickness t of 1.8 mm, a length of the enveloping portion is 7.8 mm, an inner capacity of a discharge space is 25 μl

Distance between the pair of electrodes: 4.4 mm
Discharge medium: a total inclusion amount of a metal halide ScI₃—NaI—ZnI₂ is 0.7 mg, an inclusion amount of ZnI₂ is 0.12 mg, a rare gas Xe 10 atm
Supplied power immediately after starting: 75 W
Lamp power in a stable state: 35 W
Lamp voltage in a stable state: 42 V

### Comparative Example

Discharge medium: a total inclusion amount of a metal halide ScI₃—NaI—ZnI₂ is 0.7 mg, an inclusion amount of ZnI₂ is 0.09 mg, a rare gas Xe 10 atm

Other points are the same as those in Example 2

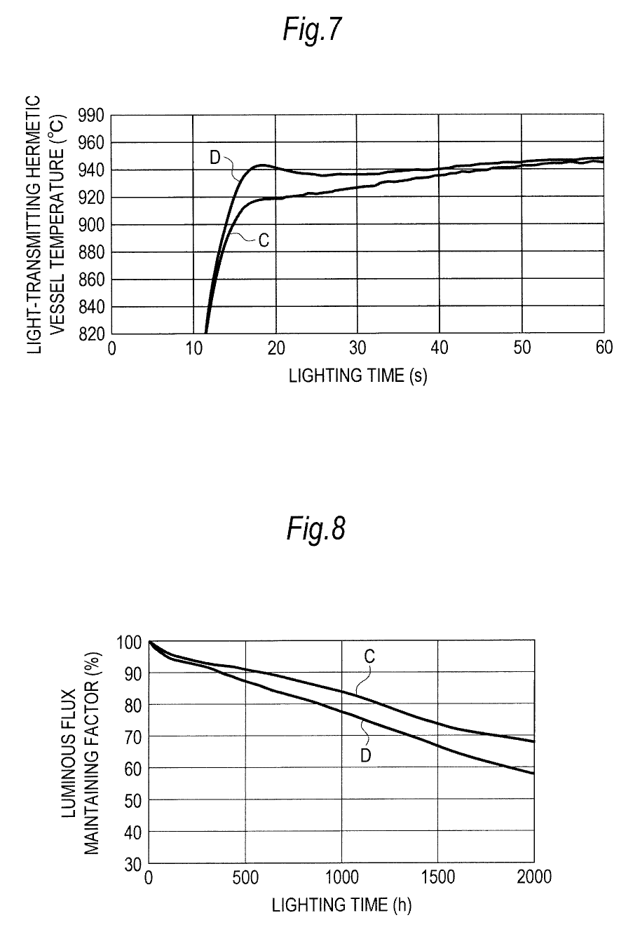

FIG. 7 is a graph showing an increase in a temperature of the light-transmitting hermetic vessel in each of Example 2 and a comparative example. In the drawing, an abscissa represents a lighting time (seconds) and an ordinate represents a temperature (° C.) of the light-transmitting hermetic vessel, respectively. In the drawing, a curve C presents Example 2 and a curve D represents the comparative example, respectively. It is to be noted that the temperature of the light-transmitting hermetic vessel is a temperature on the upper surface of the central part of the enveloping portion.

As can be understood from the drawing, although overshoot does not occur in an increase in a temperature at starting of the metal halide lamp MHL in Example 2, overshoot occurs in the comparative example.

FIG. 8 is a graph showing a luminous flux maintenance factor in each of Example 2 and the comparative example. In the drawing, an abscissa represents a lighting time (h) and an ordinate represents a luminous flux maintenance factor (%), respectively. In the drawing, a curve E represents Example 2 and a curve F represents the comparative example, respectively.

As can be understood from the drawing, the luminous flux maintenance factor is excellent in Example 2 as compared with that in the comparative example, and a difference of approximately 10% is produced between these examples when the lighting time reaches 2000 hours.

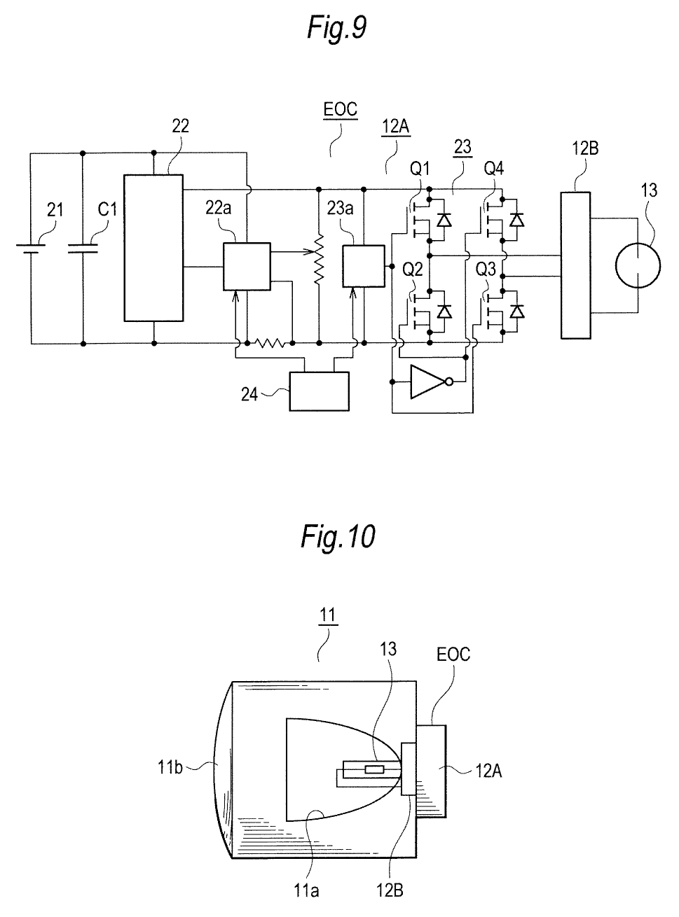

FIG. 9 is a circuit diagram showing an embodiment for carrying out a metal halide lamp lighting device according to the present invention. That is, the metal halide lamp lighting device is means for lighting a metal halide lamp 13 according to the present invention, and includes an electronic operating circuit EOC provided with a main operating circuit 12A and a starter 12B. The main operating circuit 12A is configured as described below, and can be disposed to a later-explained head light main body 11.

A metal halide lamp 13 is constituted of the metal halide lamp according to the present invention depicted in FIG. 1.

The main operating circuit 12A includes a direct-current power supply 21, a boosting chopper 22, an inverter 23, and a control circuit 24, and lights the metal halide lamp 13.

The direct-current power supply 21 is formed of, e.g., a battery power supply or a rectified direct-current power supply, and has a smoothing capacitor C1 connected between direct-current output terminals.

The boosting chopper 22 boosts a direct-current voltage supplied from the direct-current power supply 21 to a necessary voltage, smoothens this voltage, and supplies the input voltage to the later-explained inverter 23. It is to be noted that reference numeral 22a denotes a driving circuit which drives a switching element of the boosting chopper 22.

The inverter 23 is formed of a full-bridge type inverter. Further, four switching elements Q1 to Q4 are bridge-connected, a pair of switching elements Q1 and Q3 forming two opposed sides and a pair of switching elements Q2 and Q4 forming the other two opposed sides are alternately switched, thereby outputting a rectangular-wave alternating-current voltage to positions between output terminals of these elements. It is to be noted that reference numeral 23a denotes a driving circuit which drives the respective switching elements Q1 to Q4 of the inverter 23.

The control circuit 24 controls the boosting chopper 22 and the inverter 23 as required, for example, it energizes the metal halide lamp 13 with a lamp power which is twofold or above, e.g., approximately 2.3-fold of a rated lamp power for several seconds immediately after starting and then gradually reduces this power so that it finally reaches the rated lamp power in stable lighting when the metal halide lamp 13 is in a cooled state.

The starter 12B outputs a high-voltage pulse to be applied to the metal halide lamp 13 at starting of the metal halide lamp 13, thereby instantaneously starting this lamp.

In this manner, in the metal halide lamp lighting device, the electronic operating circuit EOC starts the metal halide lamp 13 to be stably lighted. Furthermore, the metal halide lamp lighting device for an automobile head light operates in such a manner the metal halide lamp 13 is started, a power which is twofold or above of the rated lamp power is continuously supplied for several seconds immediately after starting lighting, then the lamp power is reduced at a fixed rate when the halide precipitously evaporates, and the metal halide lamp is controlled and lighted so that the lamp power is gradually lowered to the rated lamp power to shift to stable lighting while sequentially reducing the reduction rate from a large value.

FIG. 10 shows an automobile head light as an embodiment for carrying out a head light according to the present invention. In the drawing, reference numeral 11 denotes a head light main body; EOC, an electronic operating circuit; and 13, a metal halide lamp.

In the present invention, the head light main body 11 is a part of the head light excluding the metal halide lamp 13 and the electronic operating circuit EOC. Moreover, the head light main body 11 has a vessel-like shape, and includes a reflection mirror 11a provided therein, a lens 11b provided on a front surface thereof, a non-illustrated lamp socket, and others.

1. A metal halide lamp comprising:
a light-transmitting hermetic vessel which has a discharge space therein and whose part facing a central part of the discharge space has a wall thickness of 1.7 mm or above;
a pair of electrodes hermitically disposed to face each other at an interval in the discharge space of the light-transmitting hermetic vessel; and
a discharge medium which contains a halide of a light-emitting metal and a rare gas, but does not substantially contain mercury (Hg), and is included in the discharge space of the light-transmitting hermetic vessel,
the lamp being configured such that, when performing lighting in such a manner that a lamp power supplied from starting up to stable lighting becomes larger than a lamp power supplied at stable lighting, a lamp voltage ratio V₁₆/V₀ satisfies the following expression:
V₁₆/V₀≧1.5
where V₁₆ (V) is a lamp voltage 16 seconds after starting and V₀ (V) is the lowest lamp voltage after starting.

2. (canceled)

3. A head light comprising:
a head light main body; and
a metal halide lamp device according to claim 4, wherein the metal halide lamp is arranged in the head light main body.

4. A metal halide lamp device comprising:
(a) a metal halide lamp comprising:
a light-transmitting hermetic vessel which has a discharge space therein and whose part facing a central part of the discharge space has a wall thickness of 1.7 mm or above;
a pair of electrodes hermetically disposed to face each other at an internal in the discharge space of the light-transmitting hermetic vessel; and
a discharge medium which contains a halide of a light-emitting metal and a rare gas, but does not substantially contain mercury (Hg), and is included in the discharge space of the light-transmitting hermetic vessel, and
(b) a metal halide lamp lighting device for supplying a lamp power to the metal halide lamp,
the metal halide lamp lighting device being configured such that, when performing lighting in such a manner that a lamp power supplied from starting up to stable lighting becomes larger than a lamp power supplied at stable lighting, a lamp voltage ratio V₁₆/V₀ satisfies the following expression:
V₁₆/V₀≧1.5
where V₁₆ (V) is a lamp voltage 16 seconds after starting and V₀ (V) is the lowest lamp voltage after starting.
